(19) United States
(12) Patent Application Publication
(10) Pub. No.: US 2003/0125914 A1
(43) Pub. Date: Jul. 3, 2003

(54) System simulation using dynamic step size and iterative model

(76) Inventor: Tan Du, Plano, TX (US)

Correspondence Address: TEXAS INSTRUMENTS INCORPORATED, P O BOX 655474, M/S 3999, DALLAS, TX, 75265

(21) Appl. No.: 10/326,693

(22) Filed: Dec. 20, 2002

Related U.S. Application Data
(60) Provisional application No. 60/344,202, filed on Dec. 28, 2001.

(51) Int. Cl. G06F 17/10

(52) U.S. Cl. 703/2

(57) ABSTRACT

Disclosed are methods, systems, and algorithms for simulating a system, such as a circuit, using an iterative model. Standard step response data is used for modeling the system and providing simulation results. Disclosed are simulation engines employing dynamically adjusted sample sizes and event scheduling. Also disclosed is the use of an approximation of the first order derivative of the simulation input to obtain the expected error for use in dynamically adjusting the step size. The use of an approximation of the second order derivative of the simulation input is also disclosed. The use of embodiments of the simulation engine with particular iterative models is described.

### RELATED APPLICATIONS

This application claims priority based on Provisional Patent Application No. 60/344202, filed Dec. 28, 2001. This application and the aforementioned provisional application have at least one common inventor and are assigned to the same entity.

### TECHNICAL FIELD

The invention relates to a black-box system simulation engine using iterative modeling. Method, system and software implementations of the invention are disclosed. The simulation engine uses dynamic step size sampling and the standard step response of a system to simulate the system in limited steps in the time-domain, without prior knowledge of frequency domain information (zero/poles and gain).

### BACKGROUND

A challenge that every semiconductor company faces is to shorten the manufacturing cycle in order to meet increasing customer demand for quick delivery of IC chips. Apart from the fabrication process, this requires that design specifications be fully checked before and during circuit design. Accordingly, it is desirable to simulate schematic designs not only at the block-level, but also at the whole-chip level for the purpose of attaining first-pass success and reducing turnover. It is difficult to simulate a large chip with a large amount of analog circuitry because current Electronics Design Automation (EDA) tools are slow in transistor-level simulation. Due to the expense associated with manufacturing, for efficiency, the test-device and code development must be fully debugged and tested before actual silicon comes out. A lack of chip block models acceptable for current test and characterization platforms make the early debugging of code and testing of devices difficult.

Other problems arise in attempting to integrate simulation methods used in different phases of the development process. It is not uncommon for resources to be wasted when different elements of the process, e.g. system, design, characterization, or test, use different test vectors, each using different models and simulators for the same blocks. Moreover, models of devices are often written in languages specific to a particular simulator platform and incompatible with other platforms. Also, most modeling and simulation tools are not transparent to designers, limiting flexibility to adapt to new designs. These problems are particularly acute when the chip is of a mixed-signal type, having both digital and analog components. The analog part of a mixed-signal chip is generally more difficult to simulate than the digital portion.

Various tools and techniques exist for simulating digital systems. For example, virtual hardware definition language (VHDL) tools may be used to simulate digital systems at the register transfer function level (RTL).

Most analog blocks of an IC are linear time-invariant (LTI) systems within their operational range. The most widely used model for a LTI system is a transfer function H(S). Usually a mix-signal EDA tool provides commands for such a model. Examples include available tools such as: MAST (a registered trademark of Analogy, Inc.); VerilogA; Verilog-AMS (Verilog is a registered trademark of Gateway Design Automation Corp.); and VHDL-AMS. However, these EDA tools usually cannot work cross-platform, and the models and simulation engines in these tools are not mutually transferable. Whatever a model looks like in the frequency domain, the end code of the model is still required by EDA simulation engines to run in the time domain. Both models and engines are not transparent to users.

So-called advanced mixed-signal (AMS) simulators known in the arts attempt to co-simulate analog and digital portion of a mixed-signal system in parallel. Using this approach, separate platforms are used for simulating analog and digital portions of the system, and the results are combined to provide an overall system result. Such attempts at mixed-signal simulations are plagued by slow run times and by their limitation to functional level simulation only, as opposed to the transistor level simulations often desired by system designers.

Existing simulation engines in known platforms (Spice, Powermill, SpectreS, Eldo, etc.) in IC design have the internal ability to step back. That is, during simulation if the engine finds that the simulation error is beyond error tolerance, it can cancel the event that has already happened, then re-schedule the event at a smaller step and try again, until the error is acceptable. The user is not able to see this ‘clock turned back’, since the engine outputs only a ‘time-forward’ result. This could be done only by having full control over the event schedule chain of the simulation engine. A customer or user of the simulation tool has no liberty to access the schedule chain.

An all-purpose mixed-signal simulation engine for electronic systems would be highly useful and advantageous in the arts. Solutions to the above and other problems would provide a simulation engine that uses a common high-level language for modeling analog and digital systems for simulation. Capabilities for dynamically adjusting the step size and rescheduling steps to provide accurate simulations would provide particular advantages including but not limited to increased efficiency and reduced design cycle time and expense.

### SUMMARY OF THE INVENTION

In general, the invention provides a simulation engine, methods, and algorithms for using an iterative model and dynamically adjusted sample sizes and event scheduling to simulate a system using the standard step response of the system. According to a preferred embodiment of the invention, a simulation method employs steps of accepting a system input signal, x(t), for simulation and computing a simulation output, y(t), using the standard step response data for the system using an iterative simulation model. In a further step, the step size, Tₛ, 387 is dynamically adjusted in order to optimize the accuracy of the simulation output.

According to a further aspect of the invention, the step of dynamically adjusting the step size, Tₛ, further includes approximating the first order derivative of the simulation input to obtain the expected error.

According to another aspect of the invention, the step of dynamically adjusting the step size, Tₛ, further includes approximating the second order derivative of the simulation input.

According to yet another aspect of the invention, the simulation model used in the invention employs the relationship:

y(tₖ)=y(tₖ₋₁)+a₁Δxₖ₋₁+a₂Δxₖ₋₂+ . . . +a_{M}Δx_{k-M} (Eq. 1).

According to still another aspect of the invention, the simulation model used in the invention employs the relationship:

$$\begin{matrix}y ( {t}_{k} ) = y ( {t}_{k - 1} ) + Δ {x}_{k - 1} p ( {t}_{k } - {t}_{k - 1} ) + \\ {\sum }_{j = n}^{k - 2} {x}_{j} [ p ( {t}_{k} - {t}_{j} ) - p ( {t}_{k - 1} - {t}_{j} ) ] .\end{matrix} \qquad ( Eq . 2 )$$

Corresponding preferred method, system, and algorithm embodiments of the invention are described.

### BRIEF DESCRIPTION OF THE FIGURES

FIG. 1 is a block diagram showing an example of a system modeling architecture for use in combination with the simulation engine of the invention;

FIG. 2 is a block diagram showing an example of the system architecture of a simulation engine according to the invention;

FIG. 3 is a conceptual view of the one-step prediction of the simulation engine of the invention; and

FIG. 4 is a process flow diagram depicting an example of the steps of the invention.

### DETAILED DESCRIPTION OF PREFERRED EMBODIMENTS

The invention will be better understood in light of the following detailed description and examples. Of course, the examples herein are illustrative only. Many alternative embodiments are possible. From the Examples shown, the broader scope of application of the concepts of the invention should be apparent to those skilled in the arts. The description references an example of the iterative modeling of related application of Du, entitled, “Linear Time Invariant System Simulation with Iterative Model,” Ser. No. 10/242,028 which is incorporated herein for all purposes. Next follows a description of the simulation engine of the invention combined with iterative modeling.

In general, it is recognized that a system responds to a given input, reacts according to its properties, and produces a given output. For a step input, a system response becomes more or less constant after a time period related to a time constant, Tₑ, particular to the system. Recognizing that significant variations in the signal settle down within a characteristic period, it may be generalized that for many systems a time period indicated by six time constants, is a preferred “settle time” useful for methods and systems for modeling a linear time invariant system. In this way, computations for the period after the settle time, Tₛ, may be avoided.

Only data within the unsettled time period carries system information. Naturally, if a variation in signal sampling is to be used, in an area where the signal has more changes it is desirable to have more sample points than during a period when the signal has less changes. In a simple example, if a unity step signal is to be curve-fitted, two sample points are sufficient to represent the main features required to duplicate the step signal. From experience it has been found that, for the normal second order dynamic system, 20˜200 points are usually sufficient to duplicate the system to a good accuracy.

Understanding of the invention may be enhanced by consideration of the description expressed in mathematical notation. After (tₖ₋₁−tⱼ)≧6Tₑ, the system settles down, and [p(tₖ−tⱼ)−p(tₖ₋₁−tⱼ)]=0. In other words, at time tₖ, only those sample points that fall into the range of (tₖ₋₁−tⱼ)≦6Tₑ are able to contribute to y(tₖ)'s summation term. Thus, as indicated by Equation (1):

y(tₖ)=y(tₖ₋₁)+a₁Δxₖ₋₁+a₂Δxₖ₋₂+ . . . +a_{M}Δx_{k-M}, (Eq. 1),

when sample length Tₛ=6Tₑ/M.

Equation (1) is a simple form for calculating the system response y(t) when there is an arbitrary input signal x(t) at a constant sampling frequency. A more general formula is shown in Equation (2), where the sampling step length Tₛ could be varied:

$$\begin{matrix}y ( {t}_{k} ) = y ( {t}_{k - 1} ) + Δ {x}_{k - 1} p ( {t}_{k } - {t}_{k - 1} ) + \\ {\sum }_{j = n}^{k - 2} {x}_{j} [ p ( {t}_{k} - {t}_{j} ) - p ( {t}_{k - 1} - {t}_{j} ) ] ,\end{matrix} \qquad ( Eq . 2 )$$

where the maximum sample step, max(Tₛ)<Tₑ/2 and (tₖ₋₁−tₙ)<6Tₑ.

Equations (1) and (2) are the time-domain models of an arbitrary system when using 6Tₑ as the preferred settle time period. If enhanced accuracy is desired, one may increase from “6Tₑ” to a higher multiple of Tₑ, say, 12Tₑ, and may select a larger number for M as well. The importance of Equations (1) and (2) is that they provide alternative iterative modeling methods for calculating the response of a system to an arbitrary input at the arbitrary accuracy required (by selecting M) for simulation of the system. The modeling and simulation systems, algorithms and methods may be implemented in the form of software, hardware, or a combination of hardware and software.

In software implementation, the model is preferably written in a common high-level language, such as C, to run on any platform accepting the common language. The model requires only the saved data points of a standard step response, denominated “standard step response data” herein, to iteratively calculate the output y(t) of the system, corresponding to an arbitrary input x(t). The standard step response data may be obtained from known simulation software, bench tests, ideal system estimation, transfer functions etc., for use with the invention.

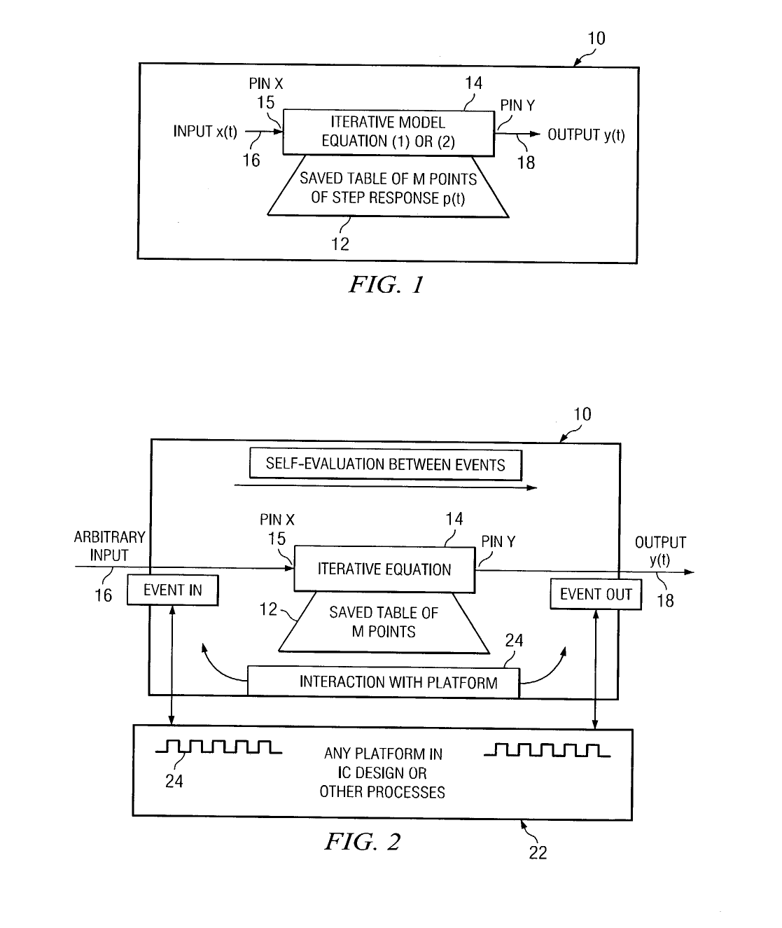

FIG. 1 is a block diagram showing an example of the architecture of the iterative model 14 useful in combination with the simulation engine 10 of the invention. Preferably, the simulation engine 10 uses standard step response data 12. In a broad sense, the block 12 representing the standard step response data not need be a table of the output/input ratio. It may be an analytical expression of unity step response or impulse response, if known. Generally any technique that can record and reproduce a step-response will serve. Block 14 represents the application of a modeling equation, preferably Equation 1 or Equation 2 herein. The modeling block 14 receives an arbitrary input 16 and provides an output 18 according to the operations further described herein by using the standard step response 12.

FIG. 2 shows a block diagram of the architecture of an example of the simulation engine 10 of the invention. The lower box represents the platform 22. Popular platforms 22 may be either event-driven or cycle-driven. The platform 22 typically uses a system clock 24 for event scheduling and triggering. The top box represents the simulation engine 10. The model 14, which is preferably an iterative model according to the related application, is shown surrounded by the engine 10 as an indication that the model 14 is used and controlled by the simulation engine 10. Note that this model 14 may alternatively be very general, linear or non-linear, time varying or time-invariant. The standard step response data 12 is used by the model 14. It can be seen that the model 14 and simulation engine 10 interact through an interface 24 for event-handling, e.g.; the event-in 16 and the event-out 18, and that in the time period between events, the simulation engine 10 manages itself. This self-management of the simulation engine 10 permits adjustments to be made in the employment of the model 14 according to the particular simulation parameters. It should be understood that the simulation engine 10 is designed to vary the use of the model 14 without alteration to the model 14 itself. The simulation engine 10 interacts with the platform 22 providing the capability of accepting an event-triggering signal from an EDA tool (not shown) and scheduling events back to the EDA tool.

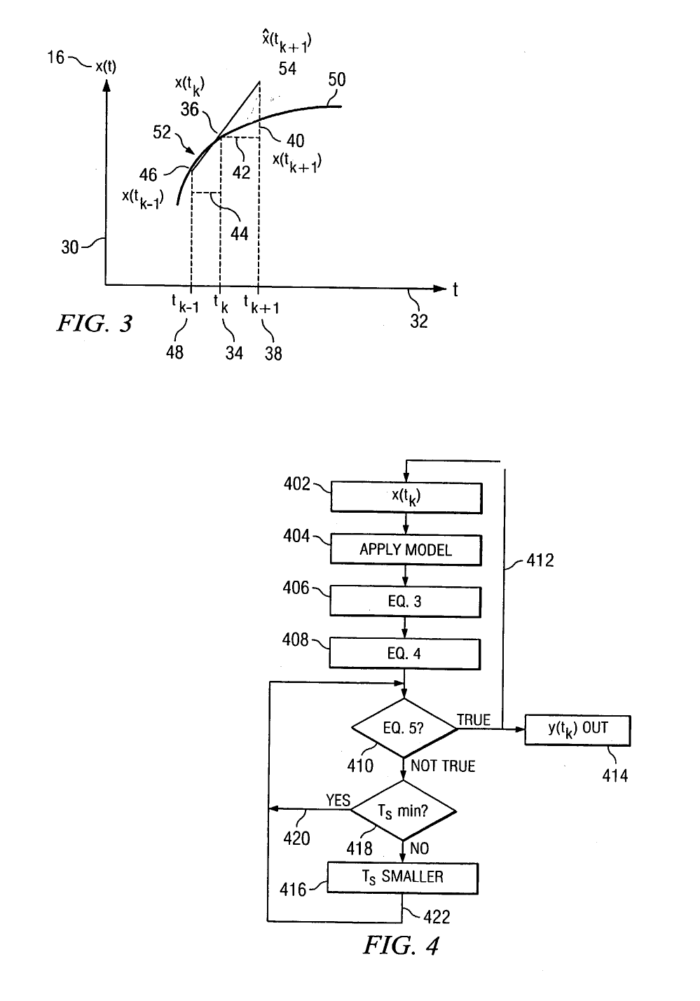

With reference primarily to FIG. 3, the capability of the simulation engine 10 to vary the use of the model 14 is further explained. A graphical representation of the “one-step prediction” of the simulation engine 10 of the invention is provided. The vertical axis 30 represents the magnitude of the input signal, x(t) 16. The horizontal axis 32 represents the time dimension. Three events indicated correspond to three discreet times indicated on the time axis 32. The time designated tₖ 34 indicates the time of a present input signal denoted x(tₖ) 36. When the simulation engine 10 completes the processing of the input signal 16 at tₖ 34 and proceeds to the next input at the next future time, tₖ₊₁ 38, the next input x(tₖ₊₁) 40, is as yet unknown. The simulation engine 20 must nevertheless use some step length, Tₛ 42, to sample for x(tₖ₊₁) 40. One alternative is to use the step length 44 of the previous input signal, x(tₖ₋₁) 46, corresponding to the previous sample time tₖ₋₁ 48.

Those skilled in the arts will appreciate that in instances such as segment 50, where the overall input signal x(t) 16 is relatively flat, or constant, a larger step length, Tₛ 42, may be used to accurately represent the signal 16. In instances, such as segment 52, where the input signal x(t) 16 changes rapidly, a smaller step length Tₛ, 44, resulting in more numerous, closely spaced samples, may be required to accurately represent the signal x(t) 16. In order to adapt the sampling to best represent the as yet unknown input signal, x(tₖ₊₁) 40, the simulation engine 10 formulates a prediction denoted the expected next input value, \hat{x}(tₖ₊₁) 54, as further described.

The expected next input value, \hat{x}(tₖ₊₁) 54, is obtained by first approximating the first order derivative according to Equation (3):

$$\frac{ⅆ x ( {t}_{k} )}{ⅆ t} = \frac{x ( {t}_{k} ) - x ( {t}_{k - 1} )}{{t}_{k} - {t}_{k - 1}} . \qquad ( Eq . 3 )$$

A proposed step length Tₛ 56, preferably the step length from the previous input x(tₖ₋₁)46, is then used to estimate the difference between the expected next input value \hat{x}(tₖ₊₁) 54 and the current input value x(tₖ) 36, as shown in Equation 4:

$$\hat{e} rr = [ \hat{x} ( {t}_{k + 1} ) - x ( {t}_{k} ) ] = {T}_{s} [ \frac{x ( {t}_{k} ) - x ( {t}_{k - 1} )}{{t}_{k} - {t}_{k - 1}} ] , \qquad ( Eq . 4 )$$

giving the expected error, êrr.

The simulation engine then compares the expected error, with a tolerance limit, Lₜₒₗ, for input x(t) estimation. Preferably, the tolerance limit is preselected according to the needs of the particular application. If the expected error exceeds the tolerance limit, êrr>Lₜₒₗ, the proposed step length Tₛ is reduced, preferably incrementally, until an acceptable relationship between expected error and tolerance limit is reached as expressed in Equation (5):

êrr =[\hat{x}(tₖ₊₁)−x(tₖ)]<Lₜₒₗ (Eq. 5).

The final time step length Tₛ 42 thus arrived at is used for the next input signal x(tₖ₊₁) 40 for the calculation of the next corresponding simulation output signal y(tₖ₊₁) 18.

The error tolerance limit, Lₜₒₗ, in Equation (5) is typically preselected subjectively. There are occasions that may lead the error-check failure even at the minimum step length Tₛ 42 due to errors in the standard step response data, or due to an especially abrupt change of input x(t) 16. In this case, as further described below the simulation engine is designed to self-adjust the error tolerance limit, Lₜₒₗ, to cause the simulation to continue.

Now referring primarily to FIG. 4, the process flow 400 of the one-step prediction of the invention is diagramed beginning with an arbitrary input X(tₖ) at step 402. Using the standard step response, the simulation model is applied to generate a simulated output signal as shown at step 404. In step 406, using the information from the previous steps, the first order derivative is approximated according to Equation 3, providing the expected next input. Using a proposed step length, in step 408, the expected error is estimated as described by Equation 4. The expected error value is then compared with a preselected error tolerance value as shown at step 410. In the event that the expected error is within tolerable limits, e.g.; the condition described by Equation 5 is true, as shown at step 412, a simulation output y(t) may be produced as indicated at step 414, and the process flow may return to step 402 to receive the next input value. If the expected error is not within tolerable limits, the proposed step length may be reduced, as shown at step 416, for the eventual reiteration of step 410, following arrow path 422. The reductions in proposed step size may, in principle, be repeated as many times as necessary to bring the expected error within acceptable tolerance limits. Preferably, a preselected minimum step length is used, as shown in step 418, to permit the process flow to continue in the event that the error tolerance limit as expressed in Equation 5 cannot be satisfied, as shown by arrow path 420. In this way, the process flow 400 is not stopped in the event of the loss of a particular input value or other unusual error event.

As described, it is desirable to vary the step length when sampling the input signal, increasing the number of sample points when x(t) changes rapidly and reducing the number of sample points when the change in x(t) is small. Thus, the duration of samples is shorter for rapidly changing inputs and longer for less rapidly changing inputs. The steps of adjusting the step length Tₛ 42 for the simulation engine of the invention described in terms of the first and second derivatives, and further illustrated in the process flow diagram of FIG. 4.

Preferably at each input signal signified by x(tₖ) the ratio is computed between the first derivative of Equation 3, and Equation 6:

$$\frac{ⅆ x ( {t}_{k - 1} )}{ⅆ t} = \frac{x ( {t}_{k - 1} ) - x ( {t}_{k - 2} )}{( {t}_{k - 1} ) - ( {t}_{k - 2} )} . \qquad ( Eq . 6 )$$

The next step length is generally proportional to this ratio. For a determination of the increase or decrease in the step length, the second order derivative shown by relationship of Equation 7 is used:

$$\frac{{ⅆ}^{2} x ( {t}_{k} )}{ⅆ {t}^{2}} = \frac{ⅆ x ( {t}_{k} ) / ⅆ t - ⅆ x ( {t}_{k - 1} ) / ⅆ t}{{t}_{k} - {t}_{k - 1}} . \qquad ( Eq . 7 )$$

The increase or decrease of the step length is determined by considering the sign of Equation 6 together with Equation 7. When Equation 6 is equal to zero consecutively, the input is constant and the step length may be increased to a preselected maximum value without loss of accuracy. This is used to handle step type input. However, if Equation 6 only takes zero momentarily, the sign of Equation 7 has to be considered to select either an enlarged or decreased step length. To illustrate, if Equation 6 produces a positive result and Equation 7 a negative result, indicating that the rate of change in the input signal is decreasing, the step length is preferably decreased to take denser sample points. Others situations are similarly implemented. With the above result for a proposed time step, Ts, the final determination of the next Tₛ is preferably still subject to the error tolerance check of Equations 3, 4, and 5.

In the time between events, the simulation engine according to the invention may be used to determine whether to self-execute its internal evaluation, for instance, on a time domain iterative model Equation (1) or (2), or it can sleep if it is determined that the input change is insignificant. The input pin 15 is preferably monitored for changes in the input signal 16. If the change in the input signal 16 is below a preselected level, the simulation engine 20 may remain inactive. If the input signal 16 is greater than a preselected level, the simulation engine 20 may be activated and begin to evaluate the input by running the simulation model 26. Of course, the invention may thus be used to self-schedule simulation events in this manner for a complete system, or for one or more individual subsystem blocks within a larger system.

Thus the invention provides simulation methods, systems, and algorithms using an iterative method of modeling a mixed-signal system of arbitrary order, using system standard step response data. By using the system settle time as a criteria to govern data sampling, the invention provides for black-box mixed-signal system simulation that is faster and more adaptable across platforms than previously available in the art. Although the implementation examples shown and described demonstrate results based on a specific application of the invention, they are not intended to limit the scope of the invention. The invention can be implemented using various simulation platforms that provide basic high-level language handling. Even though numerous characteristics and advantages of the present invention have been set forth in the foregoing description together with examples of the inventions, the disclosure is illustrative only and changes may be made within the principles of the invention to the full extent indicated by the broad general meaning of the terms used in the attached claims.

I claim:

1. A simulation engine method for simulation of a system from a simulation model having standard step response data, the method comprising:
accepting a system input signal, x(t), for simulation;
computing a simulation output, y(t), using the standard step response data for the system using the simulation model; and
dynamically adjusting step size, Tₛ, in order to optimize the accuracy of the simulation output.

2. The method according to claim 1 wherein the step of dynamically adjusting the step size, Tₛ, further comprises the step of approximating the first order derivative of the simulation input;
$$\frac{ⅆ x ( {t}_{k} )}{ⅆ t} = \frac{x ( {t}_{k} ) - x ( {t}_{k - 1} )}{{t}_{k} - {t}_{k - 1}} \qquad ( Eq . 3 )$$
in order to obtain the expected error;
$$\hat{e} rr = [ \hat{x} ( {t}_{k + 1} ) - x ( {t}_{k} ) ] = {T}_{s} [ \frac{x ( {t}_{k} ) - x ( {t}_{k - 1} )}{{t}_{k} - {t}_{k - 1}} ] . \qquad ( Eq . 4 )$$

3. The method according to claim 4 wherein the step of dynamically adjusting the step size, Tₛ, further comprises the steps of:
approximating the second order derivative of the simulation input:
$$\frac{{ⅆ}^{2} x ( {t}_{k} )}{ⅆ {t}^{2}} = \frac{ⅆ x ( {t}_{k} ) / ⅆ t - ⅆ x ( {t}_{k - 1} ) / ⅆ t}{{t}_{k} - {t}_{k - 1}} , \qquad ( Eq . 7 )$$
and using the result in order to determine whether to increase or decrease the step size, Tₛ.

4. The method according to claim 3 further comprising the step of selecting a tolerance limit, Lₜₒₗ, for use in the dynamically adjusting step wherein;
êrr≦Lₜₒₗ. (Eq. 8).

5. The method according to claim 3 further comprising the step of selecting a tolerance limit, Lₜₒₗ, for use in the dynamically adjusting step in the event that a preselected minimum step size, Tₛ, is in use.

6. The method according to claim 1 wherein the modeling step further comprises the step of modeling a multiple input/multiple output system.

7. The method according to claim 1 wherein the modeling step further comprises the step of modeling a mixed-signal system.

8. The method according to claim 1 wherein the modeling step further comprises the step of modeling a linear time invariant system.

9. The method according to claim 1 wherein the simulation model further comprises the use of the relationship:
$$\begin{matrix}y ( {t}_{k} ) = y ( {t}_{k - 1} ) + Δ {x}_{k - 1} p ( {t}_{k } - {t}_{k - 1} ) + \\ {\sum }_{j = n}^{k - 2} {x}_{j} [ p ( {t}_{k} - {t}_{j} ) - p ( {t}_{k - 1} - {t}_{j} ) ] .\end{matrix} \qquad ( Eq . 2 )$$

10. The method according to claim 1 wherein the simulation model further comprises the use of the relationship:
y(tₖ)=y(tₖ₋₁)+a₁Δxₖ₋₁+a₂Δxₖ₋₂+ . . . +a_{M}Δx_{k-M} (Eq. 1).

11. A simulation engine for simulation of a system from a simulation model having standard step response data, the simulation engine comprising means for:
accepting a system input signal, x(t), for simulation;
computing a simulation output, y(t), using the standard step response data for the system using the simulation model; and
dynamically adjusting step size, Tₛ, in order to optimize the accuracy of the simulation output.

12. The simulation engine according to claim 11 wherein the means for dynamically adjusting the step size, Tₛ, further comprises means for approximating the first order derivative of the simulation input;
$$\frac{ⅆ x ( {t}_{𝓀} )}{ⅆ t} = \frac{x ( {t}_{𝓀} ) - x ( {t}_{𝓀 - 1} )}{{t}_{𝓀} - {t}_{𝓀 - 1}} \qquad \text{(Eq. 3)}$$
in order to obtain the expected error;
$$\hat{e} r r = [ \hat{x} ( {t}_{𝓀 + 1} ) - x ( {t}_{𝓀} ) ] = {T}_{s} \frac{[ x ( {t}_{𝓀} ) - x ( {t}_{𝓀 - 1} ) ]}{{t}_{𝓀} - {t}_{𝓀 - 1}} . \qquad \text{(Eq. 4)}$$

13. The simulation engine according to claim 12 wherein the means for dynamically adjusting the step size, Tₛ, further comprises means for:
approximating the second order derivative of the simulation input:
$$\frac{{ⅆ}^{2} x ( {t}_{k} )}{ⅆ {t}^{2}} = \frac{ⅆ x ( {t}_{𝓀} ) / ⅆ t - ⅆ x ( {t}_{𝓀 - 1} ) / ⅆ t}{{t}_{𝓀} - {t}_{𝓀 - 1}} , \qquad \text{(Eq. 7)}$$
and using the result in order to determine whether to increase or decrease the step size, Tₛ.

14. The method according to claim 12 further comprising means for selecting a tolerance limit, Lₜₒₗ, for use in the dynamically adjusting step wherein;
êrr≦Lₜₒₗ. (Eq. 8).

15. The method according to claim 12 further comprising means for selecting a tolerance limit, Lₜₒₗ, for use in the dynamically adjusting step in the event that a preselected minimum step size, Tₛ, is in use.

16. A simulation algorithm for simulating a system from a simulation model having standard step response data, the algorithm comprising instructions for:
accepting a system input signal, x(t), for simulation;
computing a simulation output, y(t), using the standard step response data for the system using the simulation model; and
dynamically adjusting step size, Tₛ, in order to optimize the accuracy of the simulation output.

17. The simulation algorithm according to claim 16 wherein the step of dynamically adjusting the step size, Tₛ, further comprises the step of approximating the first order derivative of the simulation input;
$$\frac{ⅆ x ( {t}_{𝓀} )}{ⅆ t} = \frac{x ( {t}_{𝓀} ) - x ( {t}_{𝓀 - 1} )}{{t}_{𝓀} - {t}_{𝓀 - 1}} \qquad \text{(Eq. 3)}$$
in order to obtain the expected error;
$$\hat{e} r r = [ \hat{x} ( {t}_{𝓀 + 1} ) - x ( {t}_{𝓀} ) ] = {T}_{s} \frac{[ x ( {t}_{𝓀} ) - x ( {t}_{𝓀 - 1} ) ]}{{t}_{𝓀} - {t}_{𝓀 - 1}} . \qquad \text{(Eq. 4)}$$

18. The simulation algorithm according to claim 17 wherein the instructions for dynamically adjusting the step size, Tₛ, further comprise instructions for:
approximating the second order derivative of the simulation input:
$$\frac{{ⅆ}^{2} x ( {t}_{k} )}{ⅆ {t}^{2}} = \frac{ⅆ x ( {t}_{𝓀} ) / ⅆ t - ⅆ x ( {t}_{𝓀 - 1} ) / ⅆ t}{{t}_{𝓀} - {t}_{𝓀 - 1}} , \qquad \text{(Eq. 7)}$$
and using the result in order to determine whether to increase or decrease the step size, Tₛ.

19. The simulation algorithm according to claim 17 further comprising instructions for selecting a tolerance limit, Lₜₒₗ, for use in the dynamically adjusting step wherein;
êrr≦Lₜₒₗ. (Eq. 8).

20. The simulation algorithm according to claim 16 wherein the simulation model further comprises the use of the relationship:
$$y ( {t}_{𝓀} ) = y ( {t}_{k - 1} ) + Δ {x}_{𝓀 - 1} p ( {t}_{𝓀} - {t}_{𝓀 - 1} ) + {\sum }_{j = n}^{𝓀 - 2} {x}_{j} [ p ( {t}_{𝓀} - {t}_{j} ) - p ( {t}_{𝓀 - 1} - {t}_{j} ) ] . \qquad \text{(Eq. 2)}$$

21. The simulation algorithm according to claim 16 wherein the simulation model further comprises the use of the relationship:
y(tₖ)=y(tₖ₋₁)+a₁Δxₖ₋₁+a₂Δxₖ₋₂+ . . . +a_{M}Δx_{k-M} (Eq. 1).
